(19) United States
(12) Patent Application Publication
(10) Pub. No.: US 2005/0268714 A1
(43) Pub. Date: Dec. 8, 2005

(54) Fluid measurement apparatus and method

(76) Inventor: Terrance E. Watson, Houston, TX (US)

Correspondence Address: THE MATTHEWS FIRM, 2000 BERING DRIVE, SUITE 700, HOUSTON, TX, 77057, US

(21) Appl. No.: 10/861,634

(22) Filed: Jun. 4, 2004

(51) Int. Cl. G01F 23/00

(52) U.S. Cl. 73/290 B

(57) ABSTRACT

A fluid measuring device having a tube which may be lowered into a fluid. The fluid flows into the tube. This tube is then capped and raised from the fluid while still retaining the fluid in the visibly transparent tube. Length measurement demarcations are present on the tube or on the supporting backstop allowing a user to read the height of the liquid. The tube is also readily removable from its backstop for easy cleaning. The fluid measuring device can also have water sensitive paste applied to the bottom end of the device in order to test the level of water found below the fluid.

### TECHNICAL FIELD

The present invention relates generally to apparatus and methods used to measure the level of fluids.

### BACKGROUND ART

Typically, measuring the depth of a liquid in a large container, for example, measuring gasoline in a storage tank, is obtained by inserting a long dipstick into the container such that an imprint, residue or the like of the liquid is left on the dipstick. The prior art devices and methods for measuring the depth of the liquid does not provide the user with a completely accurate measurement. Residue from the liquid can cake on the measurement dipstick and obscure future readings. Furthermore, the dipstick itself can become tainted or stained by the liquid materials obscuring demarcations on the dipstick which will cause further inaccurate readings. It is to this problem that the present invention is directed.

The present invention alleviates these problems by having a visibly transparent tube into which the liquid to be measured flows. This tube is then capped at its upper end and raised from the fluid container while still retaining the fluid in the visibly transparent tube. Length measurement demarcations are present on the tube or on the supporting backstop allowing a user to read the height of the liquid. The visibly transparent tube is preferably readily removable from its backstop for easy cleaning. A water sensitive paste can also be applied to the backstop of the dipstick in order to test the level of water present in the fluid containment tank.

### BRIEF DESCRIPTION OF DRAWINGS

FIG. 1 illustrates a partial isometric, elevated view of the present invention.

FIG. 1A illustrates an embodiment of the plug element of the present invention.

FIG. 1B illustrates another embodiment of the plug element of the present invention

FIG. 2 illustrates a schematic view of an embodiment of the present invention.

FIG. 3 illustrates a partial isometric elevated view of an alternative embodiment of present invention.

The above mentioned and other objects and advantages of the present invention, and a better understanding of the principles and details of the present invention, will be evident from the following description taken in conjunction with the appended drawings.

The drawings constitute a part of this specification and include exemplary embodiments of the present invention, which may be embodied in various forms. It is to be understood that in some instances, various aspects of the invention may be shown exaggerated, reduced or enlarged, or otherwise distorted to facilitate an understanding of the present invention.

For a further understanding of the nature and objects of the present invention, reference should be had to the following detailed description, taken in conjunction with the accompanying drawings, in which like elements are given the same or analogous reference numbers.

### GENERAL DESCRIPTION AND PREFERRED MODE FOR CARRYING OUT THE INVENTION

For a further understanding of the nature, function, and objects of the present invention, reference should now be made to the following detailed description taken in conjunction with the accompanying drawings. Detailed descriptions of the embodiments are provided herein, as well as, a mode of carrying out and employing embodiments of the present invention. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure, or manner. The practice of the present invention is illustrated by the following examples which are deemed illustrative of both the process taught by the present invention and of the product and article of manufacture made in accordance with the present invention.

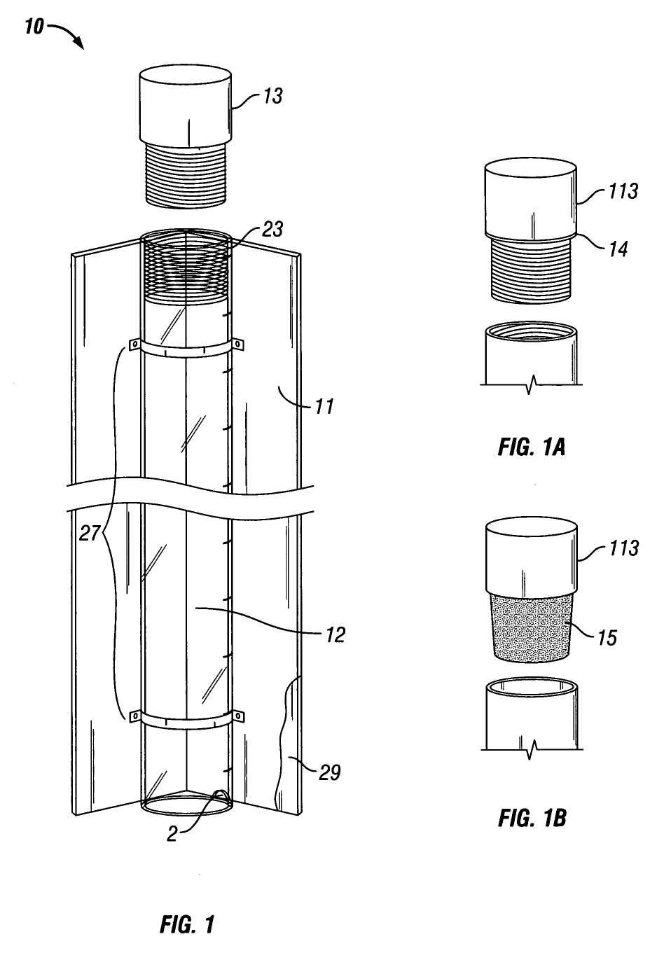

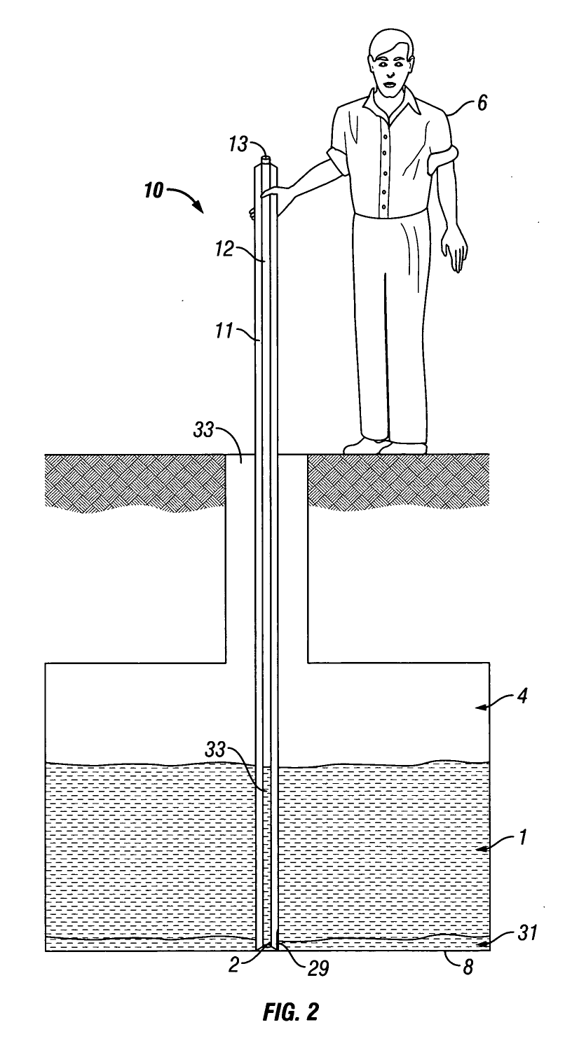

FIG. 1 illustrates a fluid measuring device 10 which comprises an elongated tubular member 12 which is substantially transparent. Present also is a backing 11 for the elongated tubular member 12 which is made preferably of a solid material such as but not limited to wood, plastic or metal. The elongated tubular member 12 is preferably both corrosive and acid resistant such as but not limited to glass, non-dissolving plastic, or the like. The elongated tubular member 12 can have any cross sectional shape, including but not limited to circular, square, triangular, hexagonal or any other cross sectional shape Measuring device 10 may be typically referred to as a dipstick. However, it should be appreciated that various terms may be used to describe the measuring device 10 and as such should not be viewed as being outside the scope of the present invention. The member 12 is preferably removable from the backing 11 and is preferably held to the backing by fasteners such as but not limited to, clamps, bands, velcro or other similar fasteners 27. It should be appreciated that the fasteners should be easily and repeatably attachable and detachable to allow for easy and efficient removal and attachment of the member 12 and the backing 11. The elongated tubular member 12 has a lower first end 2 and an upper second end 23. Second end 23 is open and preferably designed such that a sealable cap 13 may be inserted into the top of second end 23 thereby creating a substantially leak tight sealed end for the elongated tubular member 12. The sealing created by the cap 13 is preferably capable of sealing in gas. Sealable cap 13 may consist of but is not limited to a threadable top with a sealing O-ring 14 [FIG. 1A], a sealable top 113 with a sealing rubber stopper base 15 [FIG. 1B], or another sealing device, thereby creating a substantially leak tight seal. Conventional water sensitive testing paste 29 can be applied to the backing 11 or member 12 in order to test the level of water 31 present in the fluid containment tank 8 (FIG. 2). The elongated tubular member 12 is preferably etched with length measurement units, for example feet, inches, or meters. Alternatively, backing 11 may also be etched and marked with length measurement units. It should be appreciated that any type of measurement system can be applied such that the fluid level can also be measured after the fluid measuring device is removed fully from the fluid containment tank 8.

FIG. 2 shows a human operator 6 inserting the fluid measuring device 10 into the fluid containment tank 8 through containment tank orifice 3. It should be appreciated that insertion could be automatic or by methods that do not rely on operator 6. Fluid measuring device 10 will preferably have its sealable cap 13 removed during the insertion process so that the fluid 1 flows into the elongated tubular member 12. First end 2 of the fluid measuring device 10 is lowered into fluid 1 until it reaches substantially the bottom of the containment tank 8. The fluid measuring device 10 is held in a substantially perpendicular manner to the bottom of the containment tank or container 8. A gaseous area 4 may be found above the fluid layer 1 in the fluid containment tank 8. Water sensitive paste 29 applied to the backing 11 or the elongated tubular member 12 will chemically indicate the level of water 31 present in the fluid 1 by reacting chemically with the water 31 in a conventional manner thereby indicating the level of water 31 present. This reaction may be indicated by a change in color of the water sensitive paste 29 in the presence of water 31.

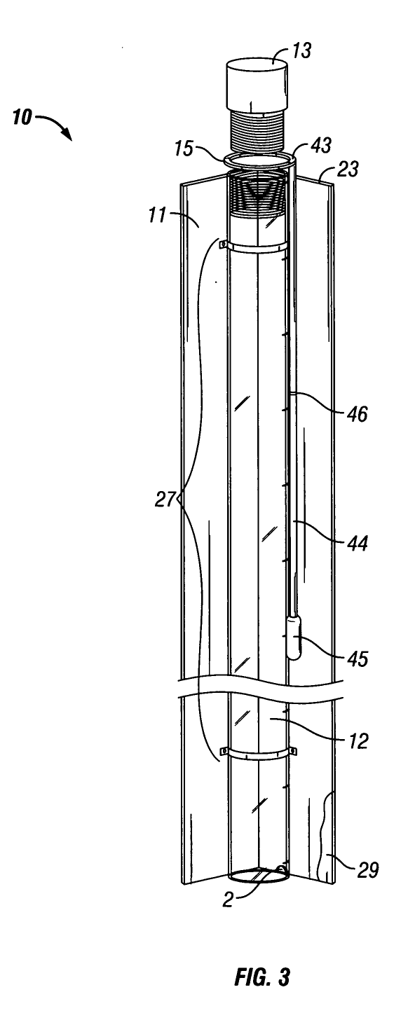

FIG. 3 is similar to the embodiment of FIG. 1 except, running substantially from the median of the backing 11 to the second end 23 is a elongated member 44 which is slideably held parallel to the longitudinal axis of tubular member 12 by a fastener such as but not limited to, clamps, bands or other similar method 46. It should be noted that elongated member 44 is not limited to a solid rod shape, but can be any shaped elongated member. Elongated member 44 has a first end 45 and a second end 43. Second end 43 comprises a plane which is preferably perpendicular to the longitudinal axis of elongated member 44 and is substantially attached to a sealable top 13 with a sealing rubber stopper base 15 (FIG. 1B). As shown the sealable top 13 is not, at the initial part of the process, sealably inserted into tubular member 12.

The operation of this invention may include, but is not limited to, the following: The sealable cap 13 of the fluid measuring device 10 is removed allowing for the elongated tubular member 12 to be open at the first end 2 and at the second end 23. As an option, the water sensitive paste 29 is then applied to the first end 2 and on the backing 11 in order to test the level of water 31 present in the fluid containment tank or container 8. The first end 2 of the fluid measuring device 10 is then inserted through the containment tank or container orifice 3 of the of the fluid containment tank 8. Fluid measuring device 10 is lowered into the fluid containment tank or container 8 in a substantially perpendicular manner in relation to the containment tank bottom until the first end 2 reaches the bottom of the fluid containment tank or container 8. At this point fluid 1 will have flowed into the elongated hollow tube 12 such that the fluid 33 in the tube is at substantially the same level in height as the fluid 1 in the containment tank or container 8.

Upon reaching the bottom of the containment tank or container 8 the sealable cap may be placed into the second end 23 of the elongated hollow tube 12 such that a seal is preferably formed between the sealable cap 13 and the second end 23. The placing of the sealable cap 13 also includes, but is not limited to, pulling elongated member 44 in the direction of first end 2. Pulling the elongated member 44 in this direction will cause second end 43 to lower and thus will also lower the sealable cap 13 into the upper end 22 of tubular member 12, thus creating a seal. This seal preferably traps the gas in the tube 12 not allowing it to escape past the drawn in fluid 33 from the containment tank or container 8. Hence, when the fluid measuring device 10 is raised out of the fluid 1 in the containment tank or container 8 the fluid level 33 is preferably maintained in the tube 12 because of the sealed end 23. Upon raising the tube 12 from the containment tank orifice 3, the operator 6 may read the level of the fluid 33 maintained in the tube 12 by viewing the height of the fluid 33 as compared to the height etchings found preferably on the transparent tube 12 or on the backing 11. The height of the fluid 33 can also be measured by reading the fluid residue left on the backing 11 or on the transparent tube 12. The water level height may be found by reading the height of the level of color change on the water sensitive paste 29 on the backing 11. After obtaining a height reading of the fluid 33 the sealable top 13 can be removed allowing for the gas trapped in the top of the tubular tube 12 to escape, the pressure to be equalized, and the fluid 33 to be released due to gravity. The fluid 33 will then preferably drain out. The aforementioned steps to utilize the disclosed invention can be done in various order.

It is noted that the embodiments described herein in detail for exemplary purposes are, of course, subject to many different variations in structure, design, application and methodology. Because many varying and different embodiments may be made within the scope of the inventive concepts herein taught, and because many modifications may be made in the embodiments herein detailed in accordance with the descriptive requirements of the law, it is to be understood that the details herein are to be interpreted as illustrative and not in a limiting sense. It will be understood in view of the instant disclosure, that numerous variations on the invention are now enabled to those skilled in the art. Many of the variations reside within the scope of the present teachings. It is not intended to limit the scope of the invention to the particular forms set forth, but on the contrary it is intended to cover such alternatives, modifications, and equivalents as may be included within the spirit and scope of the teachings of the present invention. Accordingly, the invention is to be broadly construed and is to be limited only by the spirit and scope of the claims appended hereto.

1. A fluid measuring apparatus for measuring the depth of fluids contained in a fluid containment tank comprising;
a backing;
an elongated first member, said first member being tubular and said first member being removably attached to said backing;
said elongated first member having an upper first end and a lower second end;
said first end being configured such that a seal can be applied to said first end; and
said first member having indicia on it used to measure the depth of the fluid.

2. The apparatus of claim 1 further comprising;
said backing having indicia on it used to measure depth.

3. The apparatus of claim 1 further comprising:
said first member being substantially transparent.

4. The apparatus of claim 1 further comprising;
a water sensitive paste to be applied to said backing.

5. The apparatus of claim 1 further comprising;
a water sensitive paste to be applied to said first member.

6. The apparatus of claim 1 further comprising;
said first member being comprised of material resistant to corrosion or acids.

7. The apparatus of claim 1 further comprising;
a second elongated member attached to said backing;
said second elongated member having a first end and a second end;
said second end of said second elongated member being perpendicularity attached to said seal.

8. A method for measuring the height of a fluid in a fluid containment tank, comprising the following steps in any order:
inserting a hollow tube into a fluid containment tank orifice;
uncapping said substantially hollow tube;
further lowering said substantially hollow tube in a substantially perpendicular manner into said fluid containment tank;
capping the upper end of said substantially hollow tube upon substantially reaching the bottom of said containment tank;
raising said substantially hollow tube out of the fluid containment tank with the fluid still present in the tube;
measuring the length of the fluid maintained in said substantially hollow tube.

9. The method of claim 8 further comprising;
preparing a backing attached to said substantially hollow tube;
applying a water sensitive paste to the backing in order to measure the height of water in said containment tank.

10. A fluid measuring apparatus for measuring the height of fluids comprising;
a backing;
an elongated first member, said first member being tubular and said first member being removably attached to said backing;
said elongated first member having an upper first end and a lower second end;
said first end being configured such that a seal can be applied to said first end; and
said first member having indicia on it used to measure the depth of the fluid.

11. The apparatus of claim 10 further comprising;
said backing having indicia on it used to measure depth.

12. The apparatus of claim 10 further comprising:
said first member being substantially transparent.

13. The apparatus of claim 10 further comprising;
a water sensitive paste to be applied to said backing.

14. The apparatus of claim 10 further comprising;
a water sensitive paste to be applied to said first member.

15. The apparatus of claim 10 further comprising;
said first member being comprised of material resistant to corrosion or acids.

16. The apparatus of claim 10 further comprising;
a second elongated member attached to said backing;
said second elongated member having a first end and a second end;
said second end of said second elongated member being perpendicularity attached to said seal.

17. A method for measuring the height of a fluid,
comprising the following steps in any order:
inserting a hollow tube into a fluid;
further lowering said substantially hollow tube in a substantially perpendicular manner into said fluid;
capping the upper end of said substantially hollow tube upon substantially reaching the bottom of said fluid;
raising said substantially hollow tube out of the fluid container with the fluid still present in the tube;
measuring the length of the fluid maintained in said substantially hollow tube.

18. The method of claim 17 further comprising;
preparing a backing attached to said substantially hollow tube;
applying a water sensitive paste to the backing in order to measure the height of water in said fluid container.
